(19) United States
(12) Patent Application Publication
(10) Pub. No.: US 2007/0192202 A1
(43) Pub. Date: Aug. 16, 2007

(54) Stock account/order/market price inquiry service method using a mobile terminal

(76) Inventors: Won Ki Kim, Seoul (KR); Jin Woo Ahn, Seoul (KR); Bo Kyung Seo, Gyeonggi-do (KR); Won Jun Lee, Seoul (KR); Yong Su Jeon, Seoul (KR); Hoo Jong Kim, Seoul (KR); Eun Su Jung, Gyeonggi-do (KR); Jong Sung Park, Seoul (KR); Kyung Ok Lee, Seoul (KR)

Correspondence Address: RATNERPRESTIA, P O BOX 980, VALLEY FORGE, PA, 19482-0980, US

(21) Appl. No.: 11/347,928

(22) Filed: Feb. 6, 2006

(51) Int. Cl. G06Q 30/00

(52) U.S. Cl. 705/26

(57) ABSTRACT

Disclosed is a stock account/order/market price inquiry service method using a mobile terminal that is able to perform a stock account/order/market price inquiry service through a mobile terminal using a stock chip. A stock account/order/market price inquiry service method comprising the steps of: (1) displaying a lower menu page on a mobile terminal of the stock account/order service after a PIN authentication; (2) generating an account/order service request message on the basis of stock chip information read from a stock chip and service request information corresponding to the lower menu and then transmitting the same to a relay server; and (3) receiving a service response message corresponding to service request message from the relay server and displaying the same on the screen of a mobile terminal.

### BACKGROUND

1. Field of the Invention

The present invention relates to a stock service method, particularly to a stock account/order/market price inquiry service method using a mobile terminal that is able to perform a stock account/order/market price inquiry service through a mobile terminal using a stock chip.

2. Discussion of Related Art

Recently, owing to enhancement of the performance in a mobile terminal, a remote service system is developed. The mobile terminal, which is used for enhancing a user's convenience, totally affects human society too much. For example, various interior consumer devices can be controlled from the outer through the mobile terminal. Namely, home automation technique can be embodied by the mobile terminal.

In addition to the switching function in accordance with the mentioned home automation, techniques that are able to perform an interactive service task through a mobile terminal installing a predetermined program are enlarged. The field of financial services can be given as one example. Particularly, services, such as the transfer to another bank and the identification of his/her account information of a predetermined bank, are being performed.

Also in case of the field of stock, home trading system was more developed from an initial direct trading method owing to the development of internet. Herein, in according as the home trading system is mounted at a mobile terminal using GVM (General Virtual Machine; referred to as “GVM” hereinafter) and the mobile terminal is directly driven, a stock account service using a mobile terminal is realized. Namely, a stock account service method using a WAP (Wireless Application Protocol; referred to as “WAP” hereinafter) based wireless internet was simply changed from a stock account service method using conventional cable internet.

But the mentioned conventional method has problems as follows.

At first, the mentioned conventional method has far fewer input/output means than home trading system on PC using internet, and has small memory size and thus can only be the inquiry of market price.

In addition, the method has to download corresponding contents separately because it uses a stock account service by driving a GVM based WAP browser, and inconveniently has to input a user's ID/PASSWORD.

Furthermore, because the given memory size is small, if the user's ID/PASSWORD are previously stored, the user's ID/PASSWORD have to be inputted at every times whenever the same is used and security problems are generated by each user identification through the PASSWORD input.

Finally, owing to the frequent download and the complication of usage procedure, the usage of mobile communication network is increased and then user's call ratio is decimated together with the frequent generation of overload.

### SUMMARY OF THE INVENTION

Accordingly, it is an object of the present invention to provide a stock account/order/market price inquiry service method using a mobile terminal which is able to effectively reduce the input procedure by mounting a stock chip to a mobile terminal.

In addition, it is other object of the present invention to provide a stock market price inquiry service method using a mobile terminal which is able to enhance the authentication function of a communication data and personal information between a user and securities.

Furthermore, it is another object of the present invention to provide a stock service method using a mobile terminal which is able to reduce the connection time by shortening a communication path which frequently generated between a user and securities through a hot key and thus reduce the overload of a communication network and user's call ratio.

Accordingly, it is a first aspect of the present invention to provide a stock account/order service method performing a stock account/order service, the method comprising the steps of: (1) displaying a lower menu page on a mobile terminal of the stock account/order service after a PIN authentication; (2) generating an account/order service request message on the basis of stock chip information read from a stock chip and service request information corresponding to the lower menu and then transmitting the same to a relay server; and (3) receiving a service response message corresponding to service request message from the relay server and displaying the same on the screen of a mobile terminal.

Preferably, the stock chip can be removable to the mobile terminal. More preferably, the stock chip can add an additional service function such as a prepaid traffic function except for a stock service. Most preferably, the stock chip stores FCI (File Control Information) recording code information of each securities, basic information recording an effective term and an encryption method of the stock chip, stock account information recording a concerned issue group provided to a user, an issue code corresponding to each concerned issue and an issue name corresponding to the issue code, mobile stock information recording user's personal information and login ID/PASSWORD of securities, stock bank book key recording a stock account and issuance information and key information for the renewal, and PIN (Personal Identification Number) recording a stock chip password for a user authentication.

In the embodiment, the stock chip stores initial user information in the case that the stock chip is issued in a window of securities, and a user renews and re-adjusts the user information through the adjustment function of the mobile terminal after logging in through a PIN (Personal Identification Number) authentication. Preferably, the step (1) further comprises: confirming a PIN number inputted from a user; and displaying a lower menu page corresponding to the stock account/order service on the screen of the mobile terminal in the case that after comparing the inputted PIN number with a PIN number stored at the stock chip, the comparison result is identical to each other, and displaying a service page selected from the user in the lower menu page on the screen of the mobile terminal. More preferably, the step (2) further comprises: reading information in according to a securities key, ID/PASSWORD of the securities, a dealing account number of a corresponding securities and a secret dealing number from the stock chip; generating a service request message on the basis of stock chip information read from the stock chip and a lower menu service request of the account/order service; and transmitting the service request message to a relay server. Most preferably, the step (3) further comprises: analyzing the service request message transmitted from the mobile terminal, by the relay server; transmitting a user-authenticated service request message to a securities server and a non-authenticated service request message to a market price inquiry server in accordance with the analysis result; and receiving a service response message in response to the service request from the securities server and market price inquiry server, and then transmitting the same to the mobile terminal.

Preferably, the account service request message is any one of a balance request message, a withholdings request message, an order conclusion request message, a non-conclusion request message, a reservation inquiry request message, an ECN conclusion request message, and an ECN non-conclusion request message. Also, a response message in response to the balance request message is a balance response message including volume of a balance in accordance with each issue in predetermined securities.

More preferably, a response message in response to the withholdings request message is a withholdings response message including possible order amount, possible re-purchase amount, D+2 withholdings, account receivable, possible inside-market amount and possible KOSDAQ amount. Most preferably, a response message in response to the order conclusion request message is an order conclusion response message including volume of a conclusion in accordance with each issue in predetermined securities. Further, a response message in response to the non-conclusion request message is a non-conclusion response message including volume of a non-conclusion in accordance with each issue in predetermined securities. Furthermore, a response message in response to the reservation inquiry request message is a reservation inquiry response message including the state of reservation selling/purchase in accordance with each issue in predetermined securities. Moreover, a response message in response to the ECN conclusion request message is an ECN conclusion response message including volume of an ECN conclusion in accordance with each issue in predetermined securities. In addition, a response message in response to the ECN non-conclusion request message is an ECN non-conclusion response message including volume of an ECN non-conclusion in accordance with each issue in predetermined securities.

In the embodiment, the order service request message is any one of a selling request message, a purchase request message, an amendment/cancellation request message, an ECN purchase request message, an ECN selling request message and ECN amendment/cancellation request message. Preferably, a response message in response to the selling request message and the ECN selling request message is a selling response message including issue classification, kind of trade, volume of trade, and purchase price. a response message in response to the purchase request message and the ECN purchase request message is an selling response message including issue classification, kind of trade, volume of trade, and purchase price.

In the embodiment, a response message in response to the amendment/cancellation request message and the ECN amendment/cancellation request message is any one of an issue code, trade classification, kind of trade, volume of trade, purchase price, trade volume of initial order, and amendment/cancellation price.

According to a second aspect of the present invention, there is provided a stock account/order service method using a mobile terminal which is able to remove a stock chip adding an additional service function such as a prepaid traffic function except for a stock service, the method comprising the steps of: (1) confirming a PIN number inputted from a user; (2) displaying a lower menu page corresponding to the stock account/order service on the screen of the mobile terminal in the case that after comparing the inputted PIN number with a PIN number stored at the stock chip, the comparison result is identical to each other, and displaying a service page selected from the user in the lower menu page on the screen of the mobile terminal; (3) reading information in according to a securities key, ID/PASSWORD of the securities, a dealing account number of a corresponding securities and a secret dealing number from the stock chip; (4) generating a service request message on the basis of stock chip information read from the stock chip and a lower menu service request of the account/order service; (5) transmitting the service request message to a relay server; and (6) receiving a service response message in response to the service request message from the relay server and then displaying the same on the screen of the mobile terminal.

According to a third aspect of the present invention, there is provided a stock market information service method using a mobile terminal mounting a stock chip, the method comprising the steps of: (a) generating a service request message corresponding to the selected item and then providing the service request message with a market price server in the case that a user of the mobile terminal activates a stock market price service and selects any one of market service items included in the stock market price service menu; (b) providing a data corresponding to the service request message with the mobile terminal by the market price server in case of receiving the service request message; and (c) generating a stock market price page corresponding to the data and the selected item and then displaying the generated market price page on the screen of the mobile terminal in case of receiving the data.

Preferably, the market price items include at least one of concerned issue, present price/asked price, stock price per day, chart, present futures price/asked price, present ECN price/asked price, index, and issue stock market conditions. More preferably, the step (a) further comprises: a-1) discriminating whether the selected item is the concerned item or not; a-2) reading issues stored at a concerned group stored the stock chip, generating a concerned issue page including the read issues and then displaying the generated concerned issue page on the screen of the mobile terminal in case of the concerned group selection in the discrimination result; and a-3) generating service request message corresponding to the selected issue and providing the service request message with a market price server in the case that the user selects any one of issues in the concerned issue page. Most preferably, the step (a-2) performs a PIN authentication before reading the issues from the stock chip.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 illustrates a block diagram of a stock account service system using a mobile terminal in accordance with the present invention;

FIG. 2 illustrates a storage list of a stock chip in accordance with the present invention;

FIG. 3 illustrates a service list provided from an account application in accordance with the present invention;

FIG. 4 illustrates a flow chart of a stock account service method using a mobile terminal in accordance with the present invention;

FIG. 5 illustrates a menu screen page of a stock account service in accordance with the present invention;

FIG. 6 illustrates a pin information input screen page in accordance with the present invention;

FIG. 7 illustrates a balance page in accordance with the present invention;

FIG. 8 illustrates a withholdings page in accordance with the present invention;

FIG. 9 illustrates an order conclusion page in accordance with the present invention;

FIG. 10 illustrates a non-conclusion page in accordance with the present invention;

FIG. 11 illustrates a reservation inquiry page in accordance with the present invention;

FIG. 12 illustrates an ECN conclusion page in accordance with the present invention;

FIG. 13 illustrates an ECN non-conclusion page in accordance with the present invention;

FIG. 14 illustrates a transfer page in accordance with the present invention;

FIG. 15 illustrates a bank account inquiry selection page in accordance with the present invention;

FIG. 16 illustrates a transfer confirmation page in accordance with the present invention;

FIG. 17 illustrates a service list provided from an order application in accordance with the present invention;

FIG. 18 illustrates a stock order service method using a mobile terminal in accordance with the present invention;

FIG. 19 illustrates a menu screen page of a stock order service in accordance with the present invention;

FIG. 20 illustrates a PIN information input screen page in accordance with the present invention;

FIG. 21 illustrates a selling page in accordance with the present invention;

FIG. 22 illustrates a purchase page in accordance with the present invention;

FIG. 23 illustrates an amendment/cancellation page in accordance with the present invention;

FIG. 24 illustrates an ECN selling page in accordance with the present invention;

FIG. 25 illustrates an ECN purchase page in accordance with the present invention;

FIG. 26 illustrates an ECN amendment/cancellation page in accordance with the present invention;

FIG. 27 illustrates an asked price page in accordance with the present invention;

FIG. 28 illustrates a service list provided from a market price inquiry application in accordance with the present invention.

FIG. 29 illustrates a flow chart illustrating the operation of a stock market price inquiry service system in accordance with the present invention; and

FIGS. 30 through 41 illustrate pages displayed on the screen of a mobile terminal in accordance with an exemplary embodiment of the present invention.

The following Examples are given for the purpose of illustration only and are not intended to limit the scope of this invention.

### DETAILED DESCRIPTION OF PREFERRED EMBODIMENTS

Hereinafter, preferable embodiments according to the present invention will be described with reference to the accompanying drawings. Here, when one element is connected to another element, one element may be not only directly connected to another element but also indirectly connected to another element via another element. Further, irrelative elements are omitted for clarity. Also, like reference numerals refer to like elements throughout.

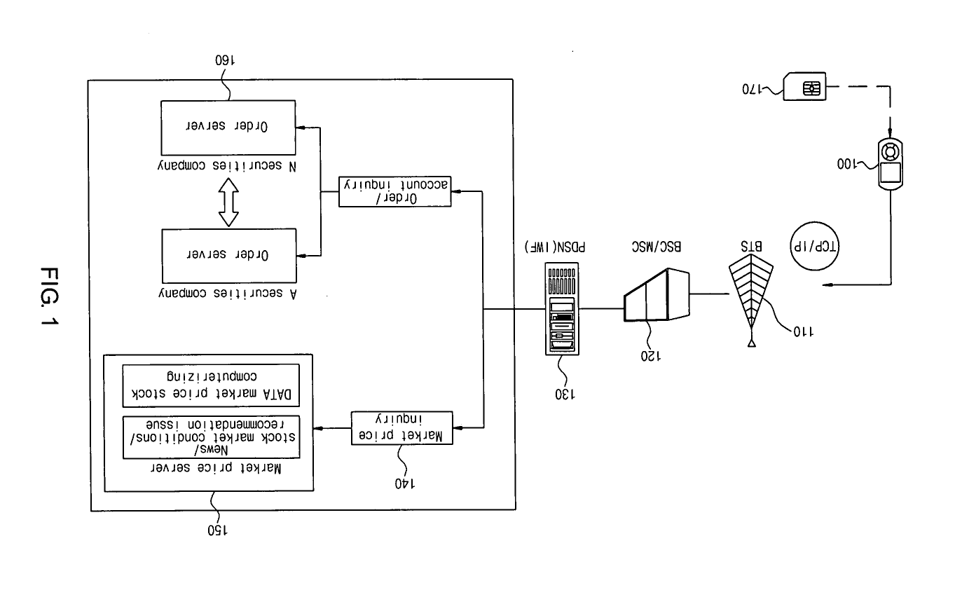

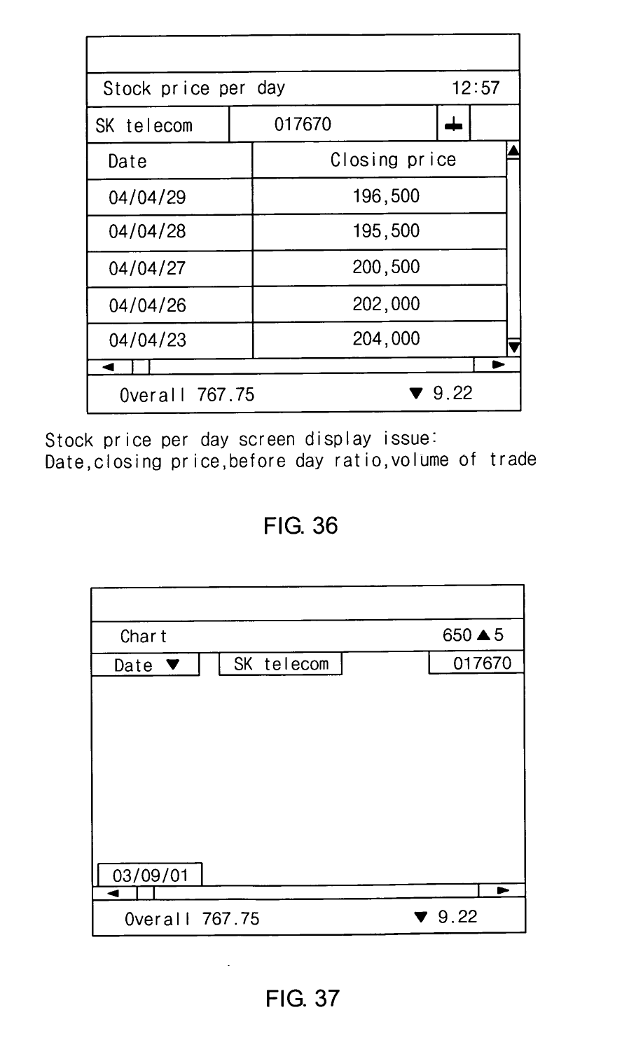

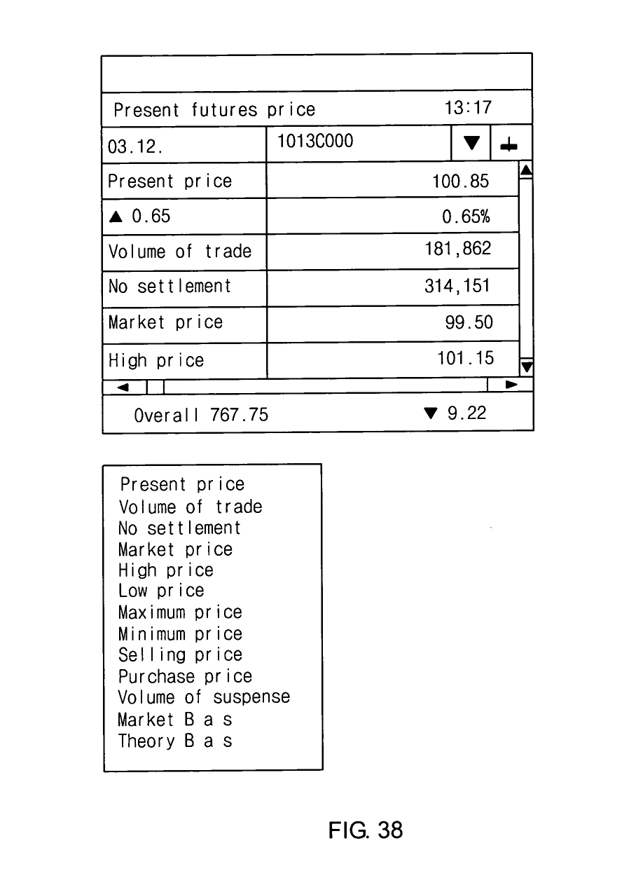

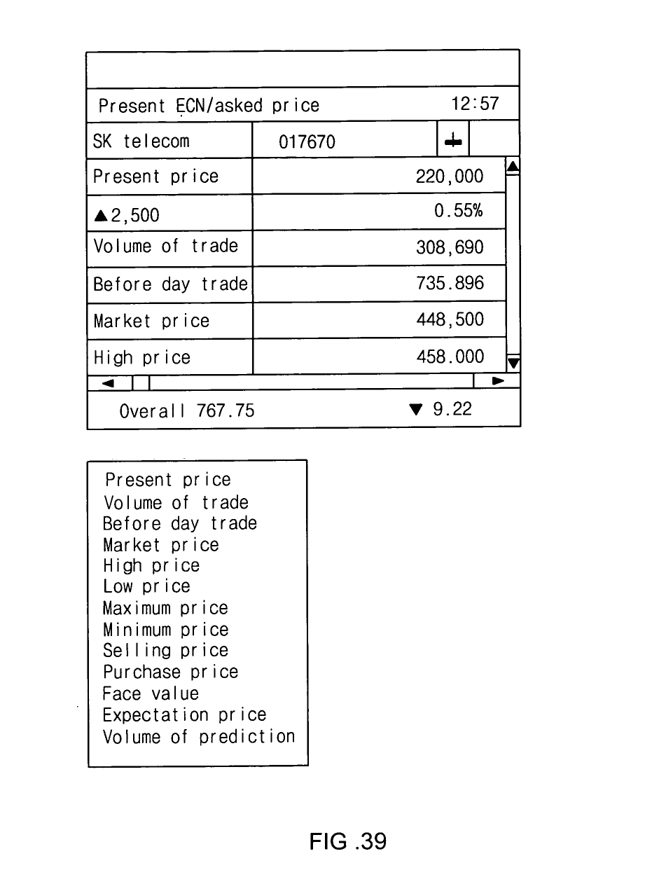

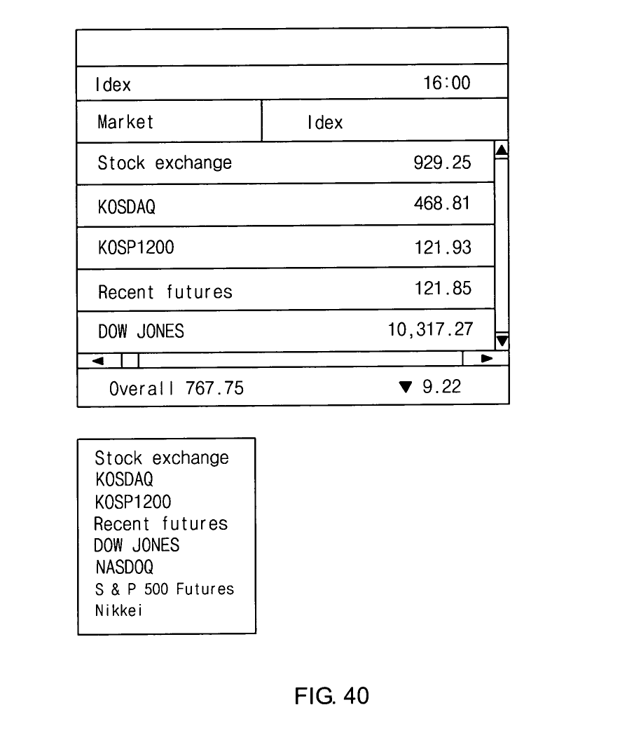

Referring to FIGS. 1 through 41, a preferable embodiment that easily embodied by a person having ordinary skill in the same art that belongs to the present invention will be described in more detail.

FIG. 1 illustrates a block diagram of a stock account service system using a mobile terminal in accordance with the present invention.

As depicted in FIG. 1, the stock service system comprises a user's mobile terminal 100, a BTS (Base station Transceiver System) 110, a BSC (Base Station Controller)/a MSC (Mobile Switching Center) 120, a PDSN (Packet Data Switch Network) 130, a relay server 140, a market price inquiry server 150, at least one of securities server 160, and a stock chip 170 removable to the mobile terminal 100.

The PDSN 130 performs a call process with the BTS 110 which performs wireless-interface with the mobile terminal 100, and provides a packet data transmission service between a RAN (Radio Access Network), which includes the BTS 110 and BSC/MSC 120 providing a core network-interface, and DCN (Data Core Network) using a PPP and TCP/IP protocol. Namely, a stock trade service in accordance with the present invention is serviced based on the TCP/IP protocol.

The relay server 140 interlocks with a mobile system including the mobile terminal 100, the BTS 110, the BSC/MSC 120, and the PDSN 130. In addition, the relay server 140 receives a market price inquiry message, an order message, an account message, and an adjustment message transmitted the mobile terminal 100, and transmits the market price inquiry message to a market price inquiry server and the order message, the account message, and the adjustment message, etc to a corresponding securities server 160.

The market price inquiry server 150 receives a market-related message (news, stock market conditions, recommended issue, stock price, etc) from the mobile terminal 100 through the PDSN 130, and then transmits the result of a corresponding to message and a related date to the mobile terminal 100 through the relay server 140, the PDSN 130, the BTS 110, and the BSC/MSC 120.

The securities server 160 receives an order message, an account message, an adjustment message, etc through the PDSN 130, performs a predetermined client authentication, processes various messages received by interlocking with an order/account server mounted in each securities and then transmits the result thereof and a related data to the mobile terminal 100 through the relay server 140, the PDSN 130, the BTS 110, and the BSC/MSC 120.

As described above, the mobile terminal 110 and the securities server 160 is accessed to each other using the TCP/IP protocol, and the transmission/reception of various data or information between them performed through a wireless TCP/IP communication using a wireless data network such as the PDSN 130.

On the other hand, the mobile terminal 100 is any one of a portable phone having related hardware devices for the wireless data-communication, a smart phone, and a PDA, etc. In addition, the mobile terminal 100 includes a removable stock chip 170, and memorizing devices (not shown) mounting related software for a market price inquiry, an order, account information, an adjustment message.

The stock chip 170 is capable of being removable to the mobile terminal 100, is made up of an IC (Integrated Chip), and a user can access to embedded information through a PIN authentication confirming the consistency by inputting PIN information which is a PASSWORD. In addition, the stock chip 170 can add an additional service function such as a prepaid traffic function, etc related to a stock account service.

The information stored at the stock chip 170, is adjusted in case of the issuance of the stock chip 170 in the window of financial institution, and after a user logs in to the stock chip 170 through a PIN authentication conforming consistence of PIN information inputted from the mobile terminal 100, renews and re-adjusts stock account information through the adjustment function of the mobile terminal 100.

The stock chip 170 can access to information embedded at the stock chip 170 only through the PIN authentication, and is used by connected with the mobile terminal 100, if necessary. Otherwise, because separate storage is available, user's convenience is provided in case of inputting information relate to a stock account, a related stock account, user information, an ID/PASSWORD of securities and thus security of the data is established.

Moreover, the mobile terminal 100 and the securities server 160 uses a SEED algorithm or an encryption method using a secession key for the security of data, user's stock and financial information in the mobile environmental.

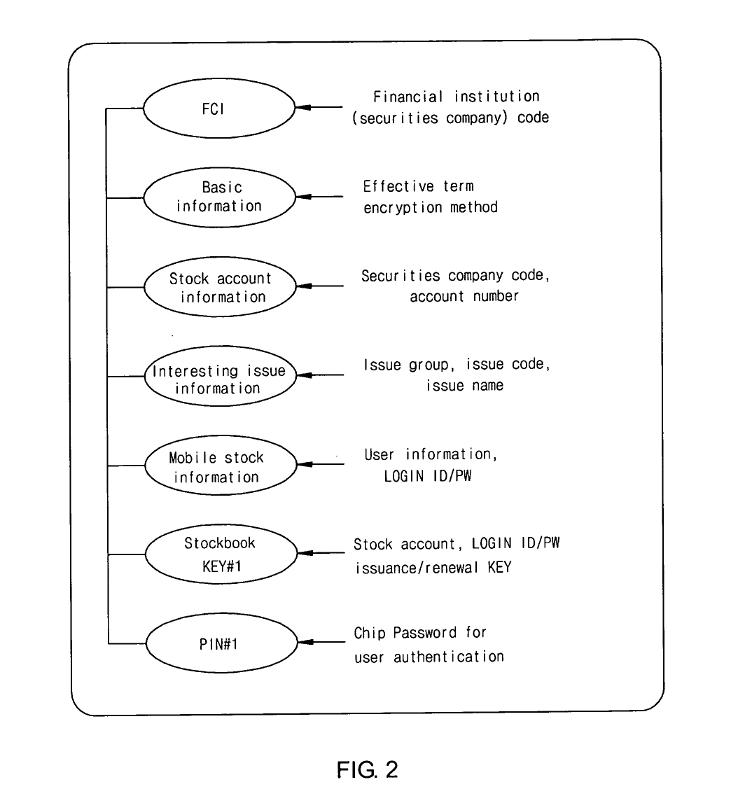

As depicted in FIG. 2, the information embedded at the stock chip 170 includes a FCI (File Control Information) recording code information of each securities, basic information recording an effective term and an encryption method of the stock chip, stock account information recording a concerned issue group provided to a user, an issue code corresponding to each concerned issue and an issue name corresponding to the issue code, mobile stock information recording user's personal information and login ID/PASSWORD of securities, stock bank book key recording a stock account and issuance information and key information for the renewal, and PIN (Personal Identification Number) recording a stock chip password for a user authentication, etc.

Respective securities download a separate stock application from a contents provision server and uses the same, and can integrate and respectively use different ID/PASSWORD. In addition, concerned issue and account information, which have to be inputted to each stock application, can be integrated as one.

The mobile terminal 100 downloads an account application through the contents provision server (not shown) storing various contents and then installs the same inside of the mobile terminal 100. In addition, the account application can be upgraded, if possible. The account application, as a software program having a series of process of a stock account service, receives data and selection command through the mobile terminal 100 or outputs an inquiry result, etc, and transmits/receives data to/from the stock chip 170, a market price inquiry server 150 and a securities server 160.

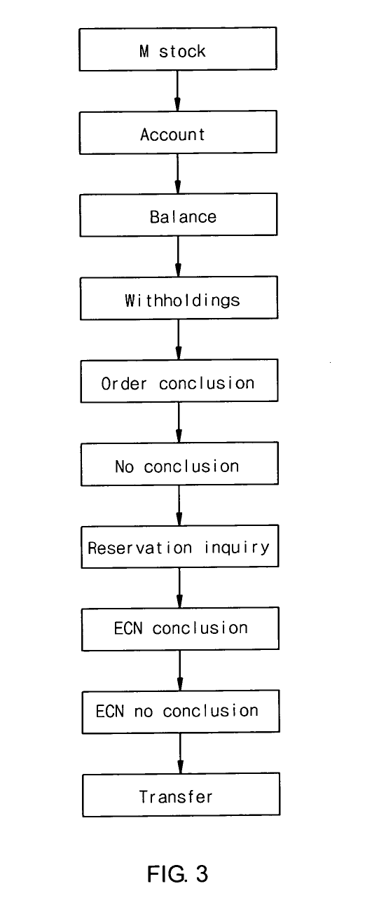

FIG. 3 illustrates a service list provided from an account application in accordance with the present invention.

Respective exemplary embodiment in accordance with the operation of a stock account service system of the present invention will be explained hereinafter. Namely, an account service among various stock services will be explained. Herein, like reference numerals refer to like elements throughout.

Particularly, because the account service needs a PIN information authentication procedure, it interlocks with the securities server 150 and with a finance server if necessary.

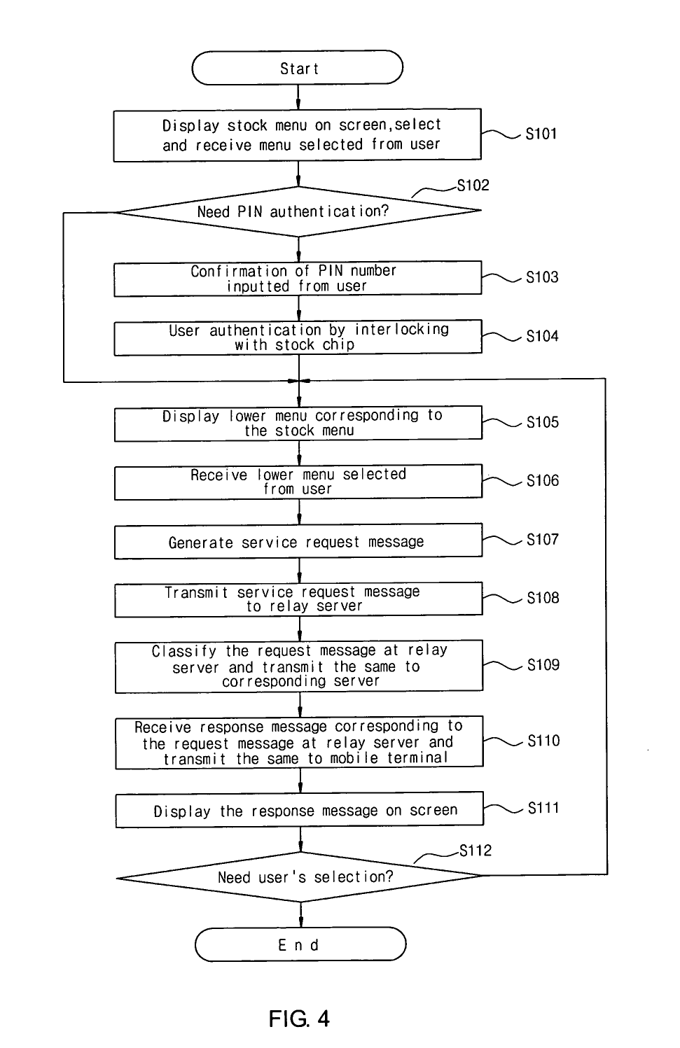

An order service method will be explained with reference to the attached FIG. 4 hereinafter.

(1) If a user selects an account service in main menu page of a stock account service provided from an account application, the account application displays a lower menu page corresponding to the account service on the screen of the mobile terminal 100 as depicted in FIG. 5 (S101).

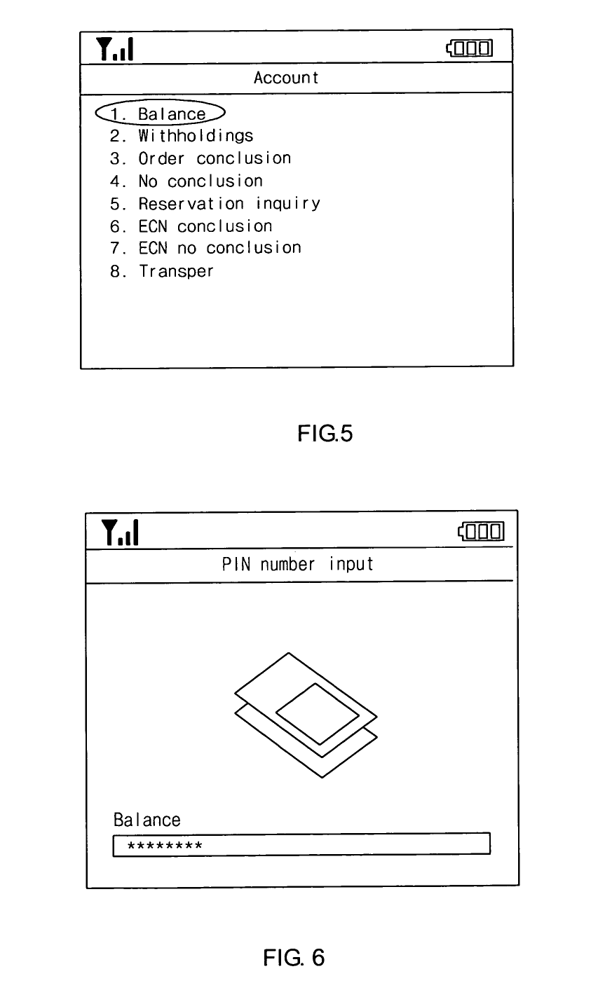

Herein, because the account service needs a PIN authentication, the account application receives a PIN number from a user by displaying a PIN input page of FIG. 6 on the screen of the mobile terminal 100 for the PIN information authentication (S102-S103).

The account application compares the inputted PIN number with PIN information stored at the stock chip 170. A lower menu page (balance, withholdings, order conclusion, non-conclusion, reservation inquiry, ECN conclusion, ECN non-conclusion) corresponding to the selected order service is displayed on the screen of the mobile terminal 100 in the case that the comparison result is consistent with each other as depicted FIG. 5 (S104-S105).

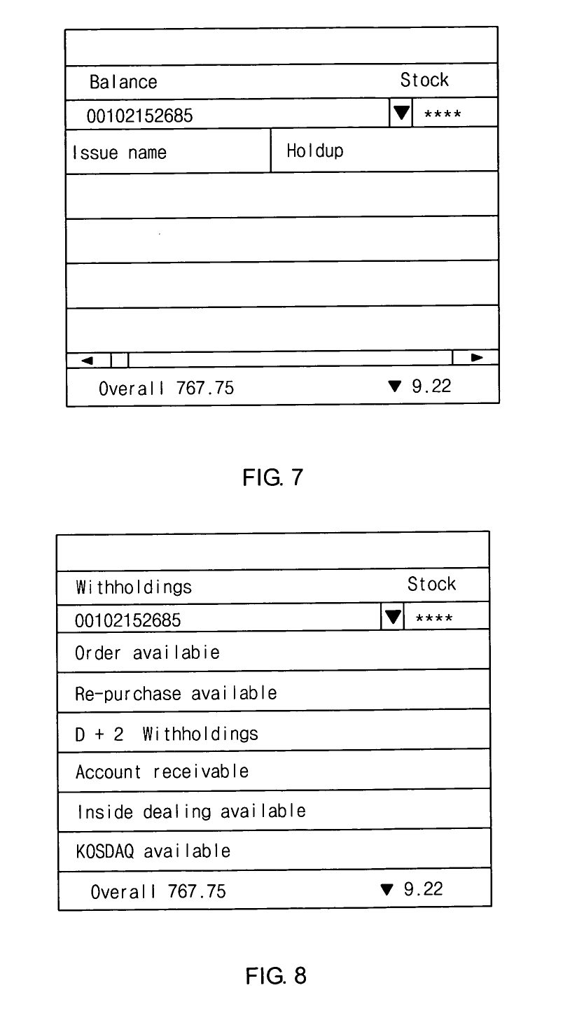

After that, the account application receives a service selected at the lower menu page from the mobile terminal 100 (S106). Herein, a balance page is displayed on the screen of the mobile terminal 100 as depicted FIG. 7 in the case that the selected service is balance.

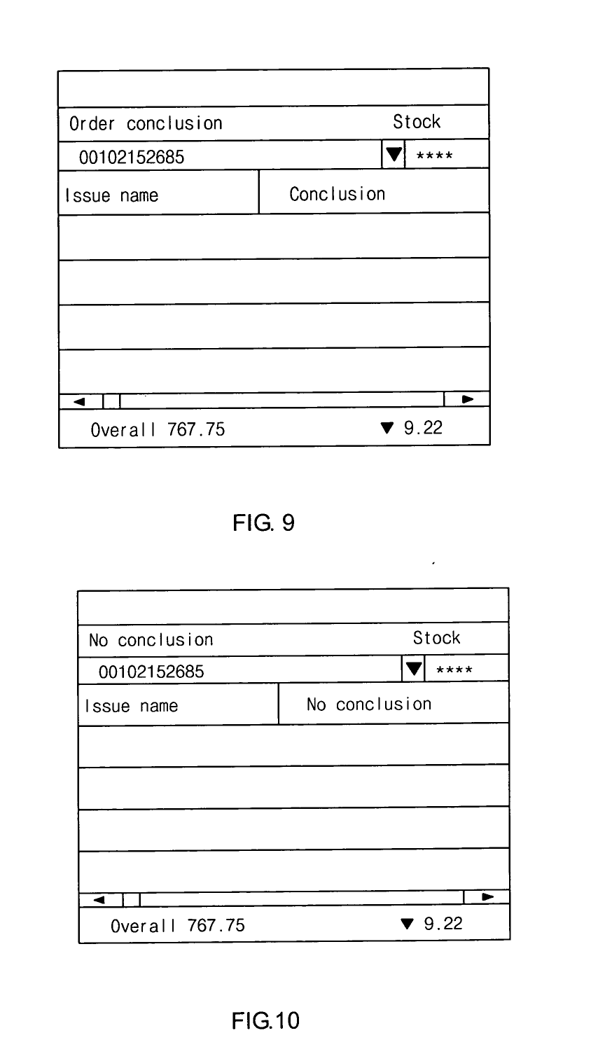

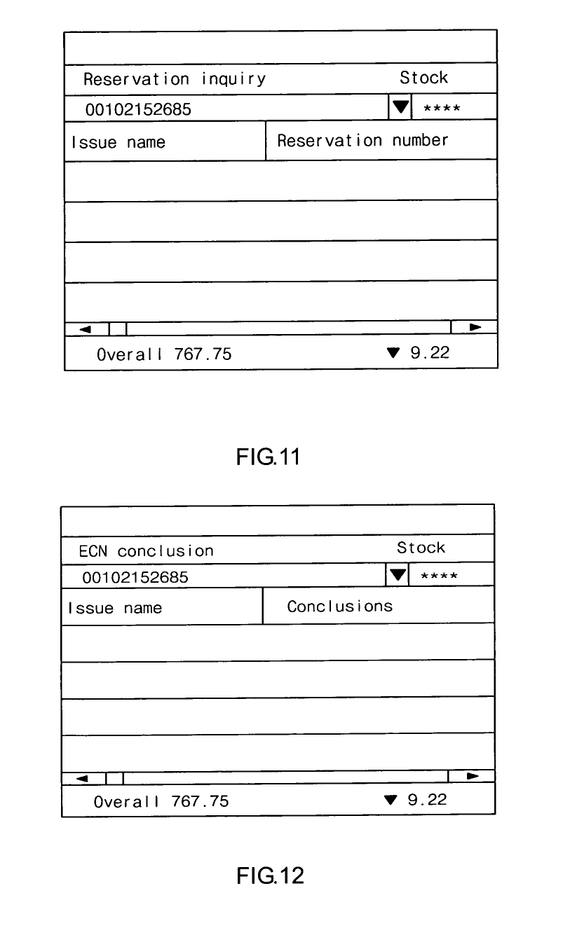

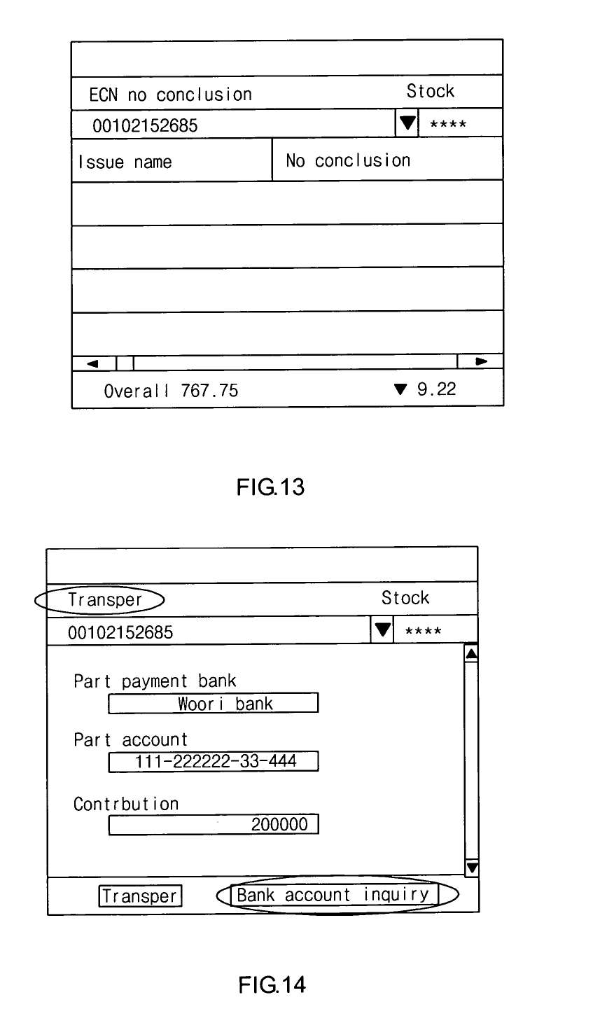

However, a withholdings page of FIG. 8 is displayed on the screen of the mobile terminal 10 in the case that the selected service is withholdings, an order conclusion page of FIG. 9 is displayed on the screen of the mobile terminal 10 in the case that the selected service is order conclusion, a non-conclusion page of FIG. 10 is displayed on the screen of the mobile terminal 10 in the case that the selected service is non-conclusion, a reservation inquiry page of FIG. 11 is displayed on the screen of the mobile terminal 10 in the case that the selected service is reservation inquiry, an ECN conclusion page of FIG. 12 is displayed on the screen of the mobile terminal 10 in the case that the selected service is ECN conclusion, and a ECN non-conclusion page of FIG. 13 is displayed on the screen of the mobile terminal 10 in the case that the selected service is ECN non-conclusion.

The account application reads information in accordance with a key of securities with which is dealing, an ID/PASSWORD of securities, trade account number of corresponding securities, trade secrete number from the stock chip 170. Herein, it is available to enable other securities (registered at the stock chip 170 previously) to be selected by displaying a page corresponding to the change of securities on the screen of the mobile terminal 100 in the case that the change of securities is requested.

In addition, the account application generates a balance inquiry request message on the basis of the stock chip information (a key of securities with which is dealing, an ID/PASSWORD of securities, trade account number of corresponding securities, trade secrete number) and the balance request (S107).

Therefore, the mobile terminal 100 transmits a balance request message including the stock chip information to the relay server 140 through the BTS 110, the BSC/MSC 120 and the PDSN 130 (S108).

The relay server 140 analyzes the balance request message transmitted from the mobile terminal 100 and transmits the same to corresponding server. In the exemplary embodiment, the analyzed message is transmitted to the securities server 160 corresponding to the securities key (S109). Thus, the securities server 160 performs a series of procedure corresponding to the balance request message and then transmits the result as a balance response message to the mobile terminal 100 through the relay server 140 (S110). Namely, the securities server 160 confirms balance volume in accordance with issue in corresponding securities.

Also in this case, a withholdings response message including order available amount, re-purchase available amount, D+2 withholdings, account receivable, Inside dealing available amount and KOSDAQ available amount is displayed on the screen of the mobile terminal 10 in the case that the service response message is withholdings, an order conclusion response message including volume of conclusion in accordance with issue is displayed on the screen of the mobile terminal 10 in the case that the service response message is order conclusion, a non-conclusion response message including volume of non-conclusion in accordance with issue is displayed on the screen of the mobile terminal 10 in the case that the service response message is non-conclusion, a reservation inquiry response message including reservation selling/purchase in accordance with issue is displayed on the screen of the mobile terminal 10 in the case that the service response message is reservation inquiry, an ECN conclusion response message including ECN conclusions in accordance with issue is displayed on the screen of the mobile terminal 10 in the case that the service response message is ECN conclusion, and a ECN non-conclusion response message including ECN conclusions in accordance with issue is displayed on the screen of the mobile terminal 10 in the case that the service response message is ECN non-conclusion.

After that, the account application receives the balance response message and displays the same on the screen of the mobile terminal 100 (S111).

(2) however, in the case that a user receives a service selecting in the lower menu page from the mobile terminal 100, if the selected service is transfer, a transfer page of FIG. 14 is displayed on the screen of the mobile terminal 100 (S105).

The account application reads information in accordance with a key of securities with which is dealing, an ID/PASSWORD of securities, trade account number of corresponding securities, trade secrete number from the stock chip 170. In addition, the account application receives bank where will be deposited, part payment account and contribution from a user (S106).

Herein, it is available to enable other securities (registered at the stock chip 170 previously) to be selected by displaying a page corresponding to the change of securities on the screen of the mobile terminal 100 in the case that the change of securities is requested.

In addition, the account application generates a balance inquiry request message on the basis of the stock chip information (a key of securities with which is dealing, an ID/PASSWORD of securities, trade account number of corresponding securities and trade secrete number), financial information to be transferred (bank where will be deposited, part payment account) and the transfer request (S107).

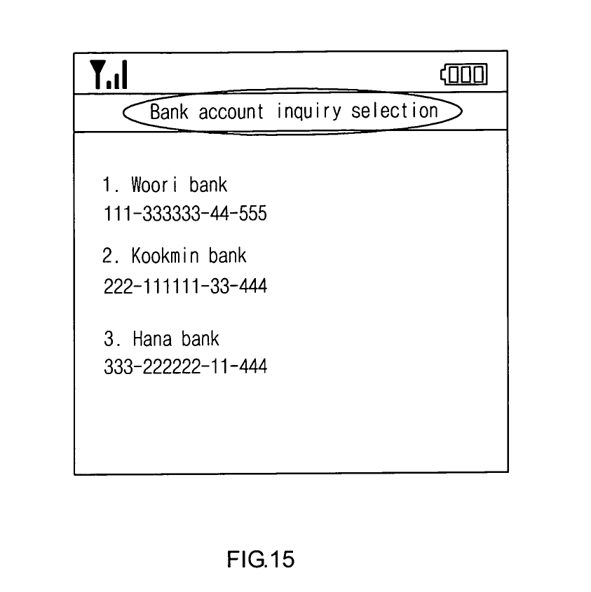

Herein, in the case that bank where will be deposited, part payment account or the change of account number are requested, bank or account can be changed by displaying a bank account inquiry selection page of FIG. 15 on the screen of the mobile terminal 100 in order that a user selects the bank and an account read from the stock chip 170.

Therefore, the mobile terminal 100 transmits a transfer request message including the stock chip information and financial information to the relay server 140 through the BTS 110, the BSC/MSC 120 and the PDSN 130 (S108).

The relay server 140 analyzes the transfer request message transmitted from the mobile terminal 100 and transmits the same to corresponding server (S109). In the exemplary embodiment, the analyzed message is transmitted to the securities server 160 corresponding to the securities key. Thus, the securities server 160 performs a series of procedure corresponding to the transfer request message and then transmits the result as a transfer response message to the mobile terminal 100 through the relay server 140 (S110). Namely, the securities server 160 generates a transfer response message including contributed stock account, deposited bank name and part payment account, contribution, and commission, etc in corresponding securities.

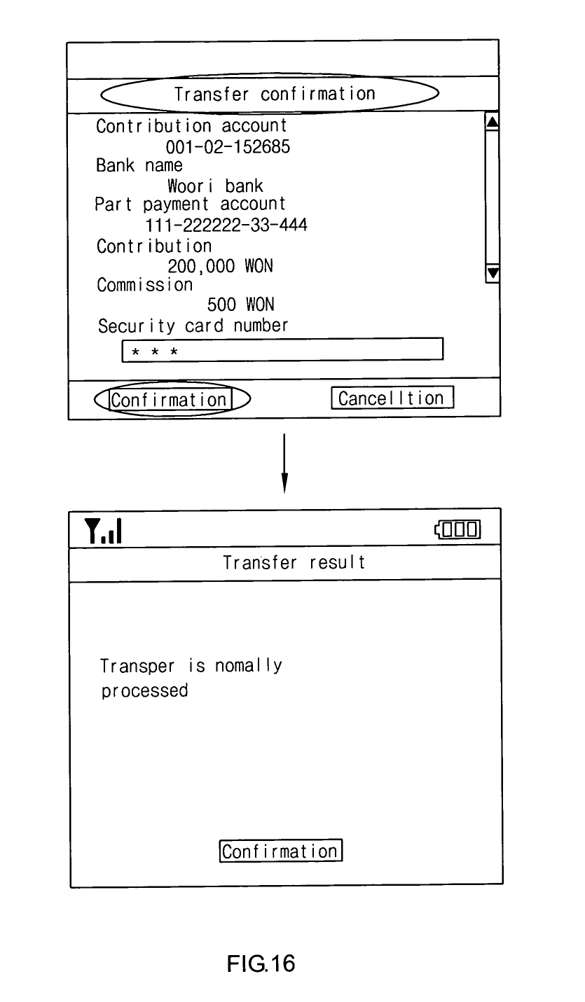

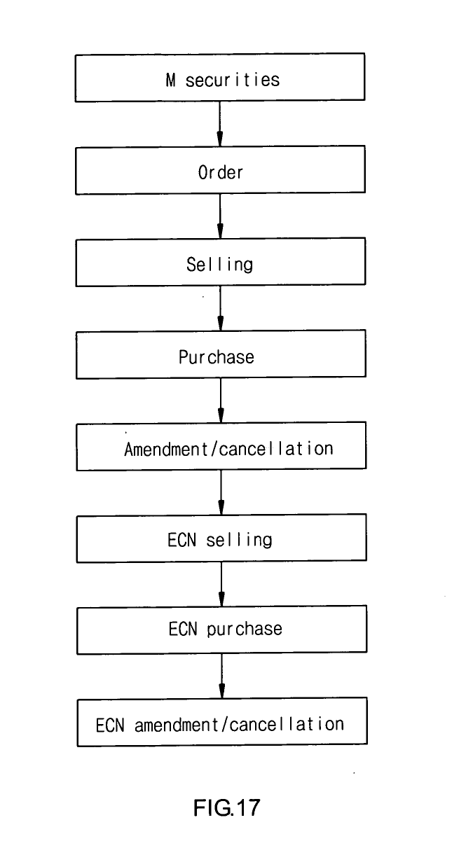

After that, the account application receives the transfer response message and displays the transfer confirmation page of FIG. 16 on the screen of the mobile terminal 100 (S111).

FIG. 17 illustrates a service list provided from an order application in accordance with the present invention.

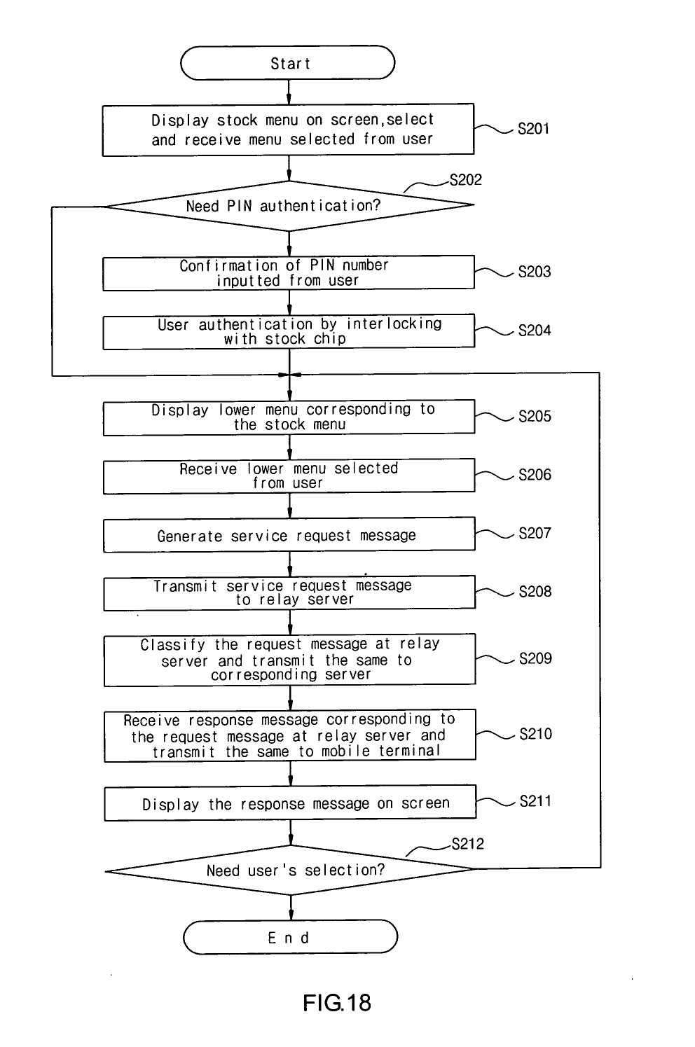

Respective exemplary embodiment in accordance with the operation of a stock order service system of the present invention will be explained hereinafter. Namely, various stock order services (selling, purchase, amendment/cancellation, ECN purchase, ECN selling and ECN amendment/cancellation) will be explained with reference to FIG. 18. Herein, like reference numerals refer to like elements throughout.

Particularly, because the order service needs a PIN information authentication procedure, it interlocks with the securities server 150 and with a market price inquiry server if necessary.

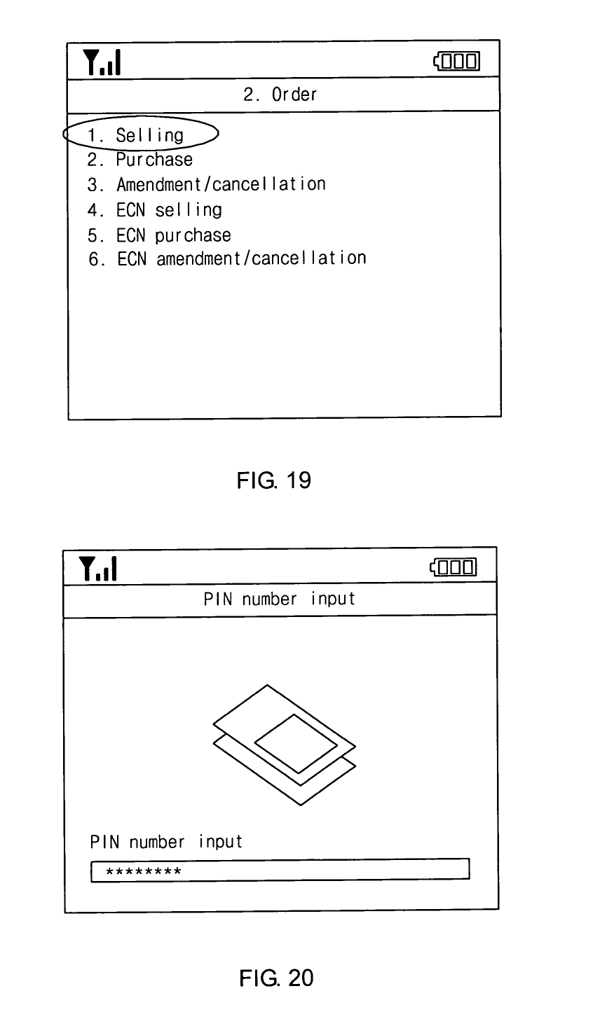

(1) If a user selects an order service in main menu page of a stock order service provided from an order application, the order application displays a lower menu page corresponding to the order service on the screen of the mobile terminal 100 as depicted in FIG. 19 (S201).

Herein, because the order service needs a PIN authentication, the order application receives a PIN number from a user by displaying a PIN input page of FIG. 20 on the screen of the mobile terminal 100 for the PIN information authentication (S202-S203).

The order application compares the inputted PIN number with PIN information stored at the stock chip 170. A lower menu page (selling, purchase, amendment/cancellation, ECN purchase, ECN selling and ECN amendment/cancellation) corresponding to the selected order service is displayed on the screen of the mobile terminal 100 in the case that the comparison result is consistent with each other (S204-S205).

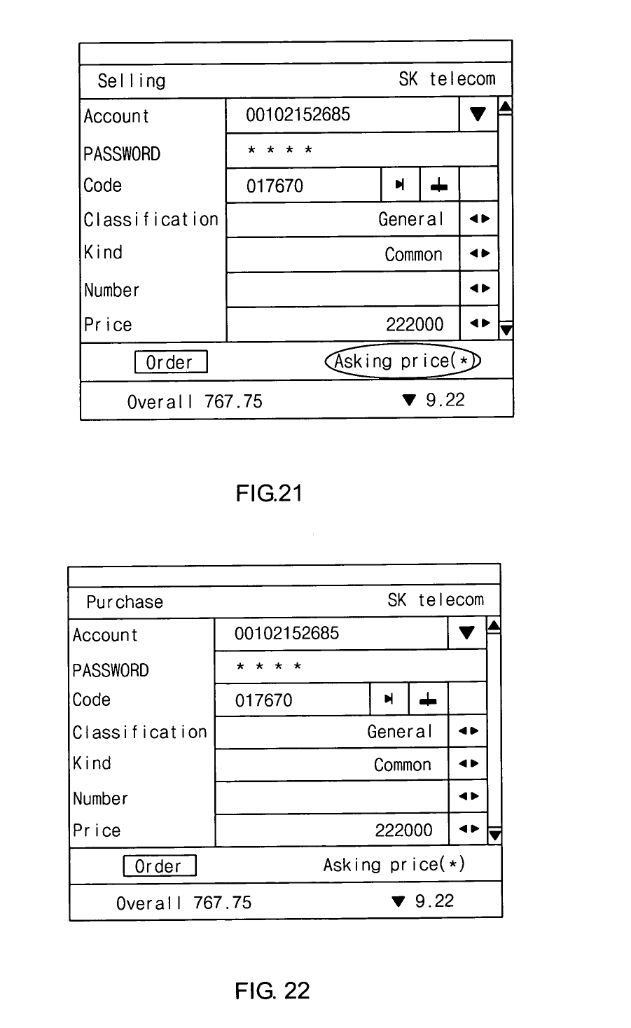

After that, the order application receives a service selected at the lower menu page from the mobile terminal 100 (S206). Herein, the selling page is displayed on the screen of the mobile terminal 100 as depicted FIG. 21 in the case that the selected service is selling.

Because the other lower menus of the order service are highly identical to the case of the mentioned selling, detailed explanation thereof will be omitted.

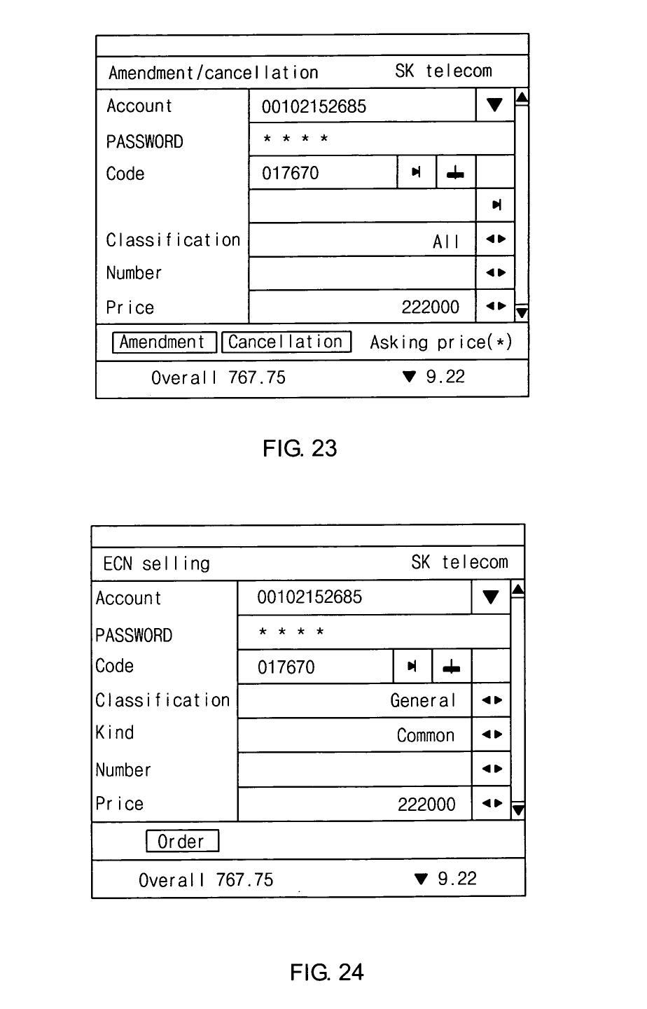

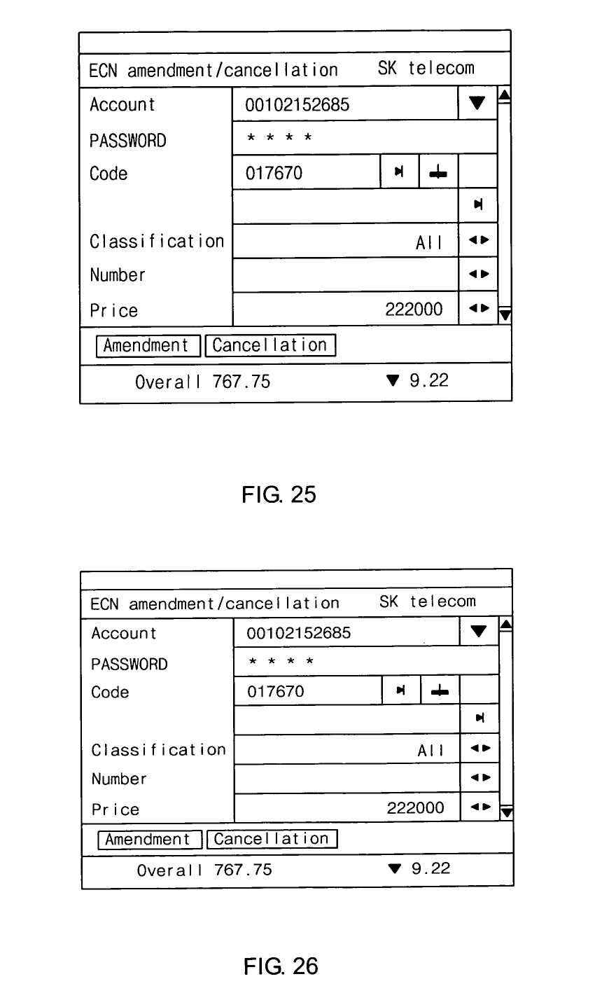

However, a purchase page of FIG. 22 is displayed on the screen of the mobile terminal 10 in the case that the selected service is purchase, an amendment/cancellation page of FIG. 23 is displayed on the screen of the mobile terminal 10 in the case that the selected service is amendment/cancellation, an ECN selling page of FIG. 24 is displayed on the screen of the mobile terminal 10 in the case that the selected service is ECN selling, an ENC purchase page of FIG. 25 is displayed on the screen of the mobile terminal 10 in the case that the selected service is an ECN purchase, an ECN amendment/cancellation page of FIG. 26 is displayed on the screen of the mobile terminal 10 in the case that the selected service is ECN amendment/cancellation.

The order application reads information in accordance with a key of securities with which is dealing presently, an ID/PASSWORD of securities, trade account number of corresponding securities, trade secrete number from the stock chip 170 for generating a service request message. And the order application receives detailed specification from a user (namely, corresponding issue code and trade classification, kind of trade, volume of trade, selling price) by displaying the selling page on the screen of the mobile terminal 100.

Herein, it is available to enable other securities (registered at the stock chip 170 previously) to be selected by displaying a page corresponding to the change of securities on the screen of the mobile terminal 100 in the case that the change of securities is requested.

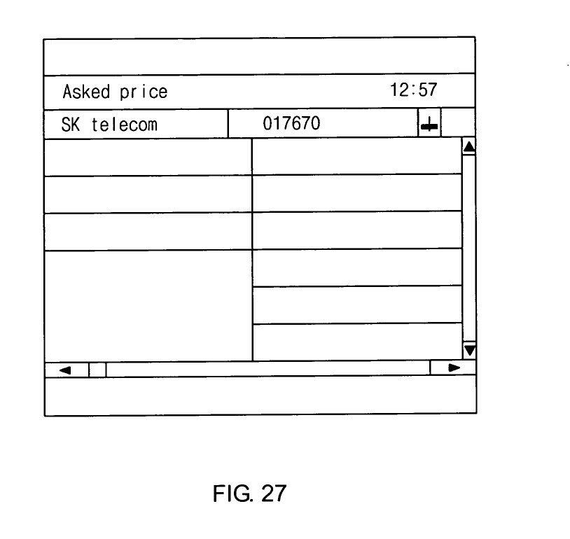

On the other hand, if a user requests present asked price (namely, if a user selects an asked price key of the selling page), the order application displays the asked price page of FIG. 27 on the screen of the mobile terminal 100.

Demand of the asked price information and response thereof, because they interlock with the market price inquiry server 150, is different from the order procedure in accordance with the PIN authentication procedure.

Accordingly, procedure in accordance with demand of the asked price information and response thereof will firstly be explained, and an order service will secondly be explained.

The order application generates an asked price information request message, and transmits the same to the relay server 140 through the BTS 110, the BSC/MSC 120 and the PDSN 130. Asked price included at the asked price information request message can be any one of present price, volume of trade, market price, high price, and low price, etc, and can be made up of the remainder of purchase such as 5 step asked price window and related values, and the remainder of selling and related values.

The relay server 140 analyzes the asked information transmitted from the mobile terminal 100, and transmits the asked information request message to corresponding server (for example, a market price inquiry server 150 because of an asked information request message).

Accordingly, the market price inquiry server 150 generates information corresponding to the asked information request message as an asked price information response message, and transmits the same to mobile terminal 100. After that, the mobile terminal 100 receives the asked price information response message, and displays an asked page of FIG. 27 on the screen.

The procedure in accordance with demand of the asked price information and response thereof was finished and then an order procedure after the step S206 will be explained hereinafter.

On the other hand, the order application receives selling information (corresponding issue code and trade classification, kind of trade, volume of trade, selling price) from a user, and generates a selling request message on the basis of the stock chip information (a key of securities with which is dealing, an ID/PASSWORD of securities, trade account number of corresponding securities and trade secrete number) and the selling information (S207).

Accordingly, the mobile terminal 100 transmits a selling request message to the relay server 140 through the BTS 110, the BSC/MSC 120 and the PDSN 130 (S208).

Herein, purchase information, selling information and ECN purchase information are identical to the selling information, but amendment/cancellation information and ECN amendment/cancellation information further include corresponding issue code and trade classification, trade volume of initial order, and amendment/cancellation price.

The relay server 140 analyzes the selling request message transmitted from the mobile terminal 100, and transmits the same to corresponding server (S209).

In the exemplary embodiment, the selling request message is transmitted to the securities server 160 corresponding to the securities key. Accordingly, the securities server 160 performs a series of procedure corresponding to the selling request message and then transmits the result as a selling response message to mobile terminal 100 through the relay server 140 (S210).

After that, the order application receives the selling response message, and displays a selling result page on the screen of the mobile terminal 100 (S211).

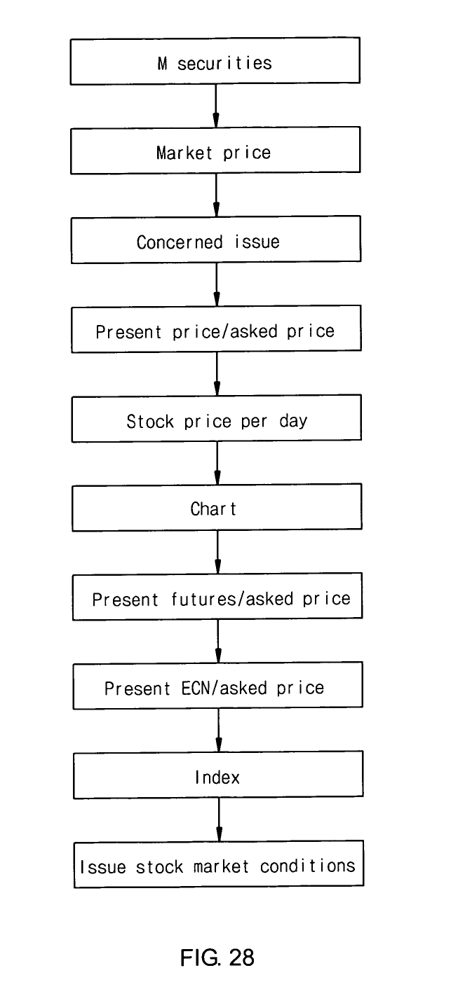

FIG. 28 illustrates a service list provided from a market price inquiry application in accordance with the present invention.

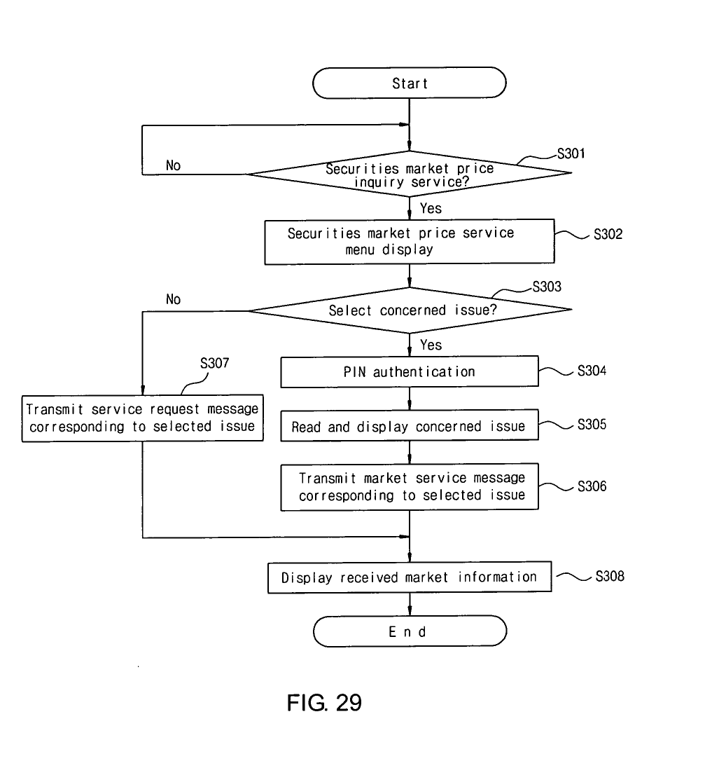

FIG. 29 is a flow chart illustrating the operation of a stock market price inquiry service system in accordance with the present invention.

Respective exemplary embodiments in accordance with the operation of a stock market price inquiry service system in the present invention will be explained with reference to the attached drawings hereinafter. Herein, like reference numerals refer to like elements throughout.

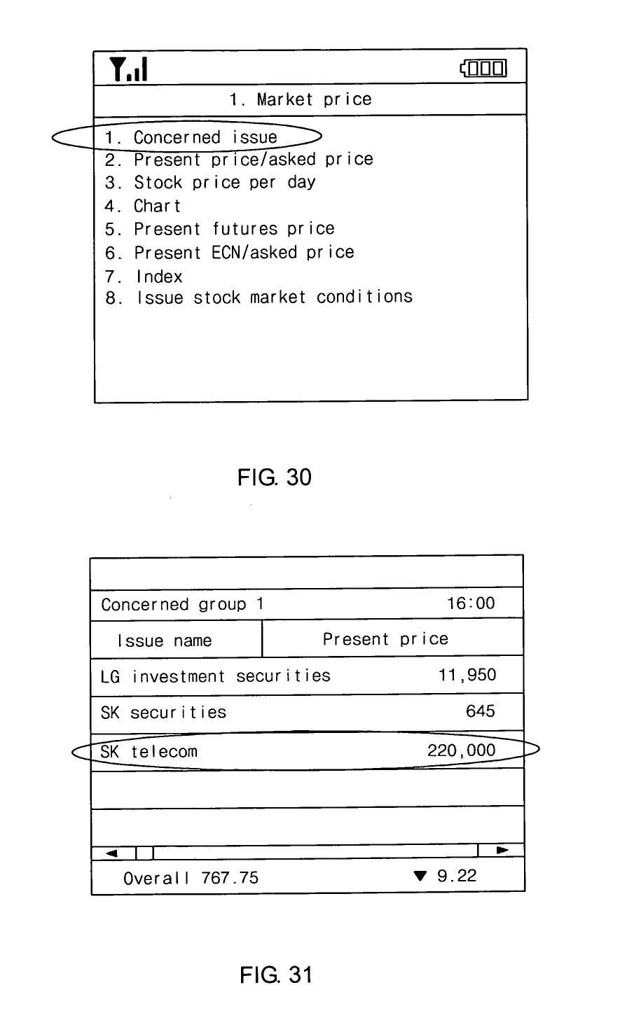

A market price inquiry application, if a stock market price inquiry service is selected from a user, displays a market page of FIG. 30 on the screen of the mobile terminal 100.

A lower menu includes a service such as concerned issue, present price/asked price, stock price per day, chart, present futures price, present ECN/asked price, index, and issue stock market conditions.

(1) Concerned issue and issue stock market conditions

After that, the market price inquiry application receives a user selection key from the market price menu page. Herein, the user selects a concerned issue among the market price menu pages (S301, S302, S303).

The concerned issue is made up of at least one of concerned group in order to be managed as a group unit, and a lower group in accordance with the concerned group is made up of issue name and present price. Herein, the concerned issue is stored at the stock storage 170, and is applied according as the market price inquiry application reads the concerned group after a PIN authentication. In addition, the concerned issue can be renewed or changed (S303, S304, S305).

Accordingly, the market price inquiry application generates the selected information (for example, concerned issue in market price inquiry) as a service request message (namely, present price in accordance with concerned issue). And after the market price inquiry application gets socket-access to the relay server 140 through the BTS 110, the BSC/MSC 120 and the PDSN 130 and then constitutes a data transmission line, it transmits the same to the relay server 140 through the BTS 110, the BSC/MSC 120 and the PDSN 130 (S306, S307).

The relay server 140 analyzes a service request message transmitted from the mobile terminal 100, and transmits the same to corresponding server (namely, market price inquiry server 150).

The market price inquiry server 150 generates information corresponding to the service request message as a response message, and transmits the same to mobile terminal 100. Namely, the market price inquiry server 150 generates a response message corresponding to a present value request message in accordance with concerned issue, and transmits the same to mobile terminal 100.

After that, a market price inquiry application generates a concerned issue page as depicted in FIG. 31 on the basis of the service response message, and displays the concerned issue page on the screen of the mobile terminal 100 (S308).

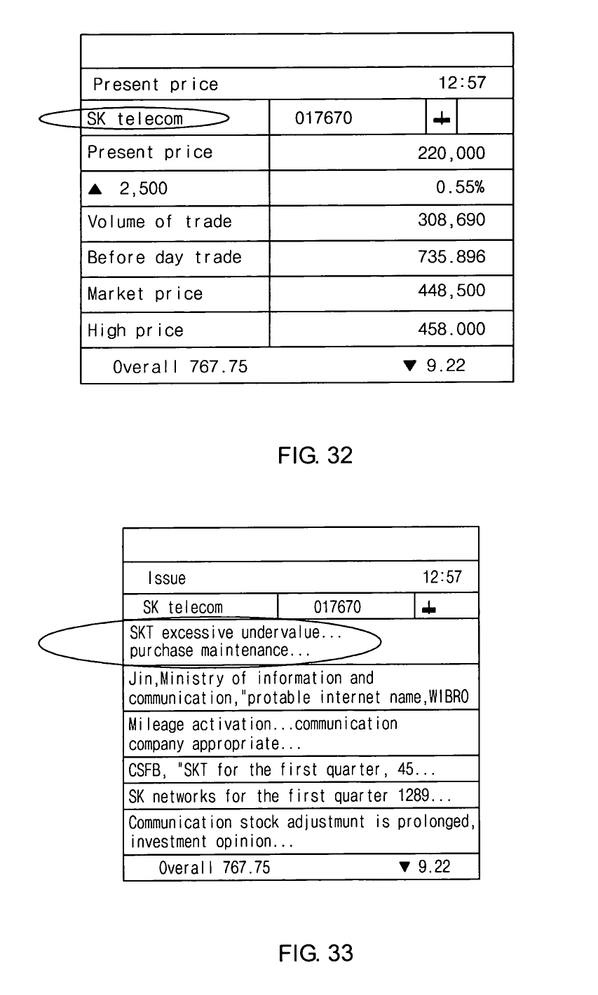

Herein, the procedure is repeated in the case that the service response message has a predetermined list form. Namely, after one issue among present value list in accordance with the concerned issue is inputted by a user, the issue is generated as a present value request form of the selected issue, information related to the selected issue is inputted as a service response message form and then the same is displayed at a present page as depicted in FIG. 32 on the screen of the mobile terminal 100. Herein, the service response message includes issue name, present value, value over the day before, advance-decline ratio, volume of trade, remainder of total selling and remainder of total purchase.

In addition, the market price inquiry application receives a user selection key from the market price menu page displayed in the mobile terminal 100. Herein, if a user selects issue market conditions among the market price menus, the market price inquiry application displays an issue market conditions page of FIG. 33 on the screen of the mobile terminal 100.

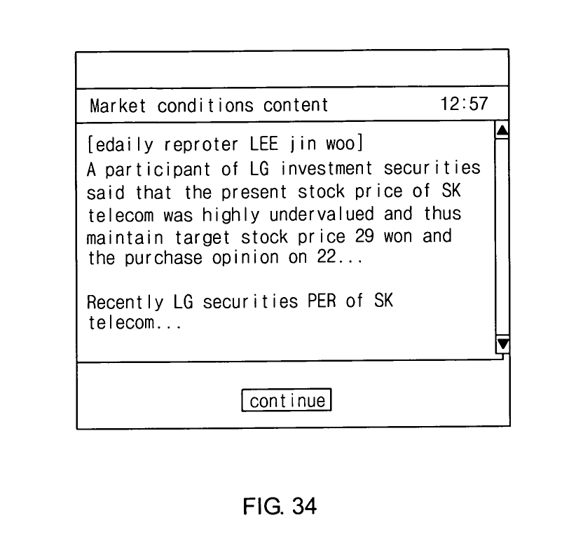

Because later procedure is highly identical to the case of the concerned issue, detailed explanation thereof will be omitted. And the selected issue, information related to the selected issue is inputted as a service response message form and then the same is displayed at a present page as depicted in FIG. 34.

(2) Present price/asked price, stock price per day, chart, present futures price, present ECN price/asked price and index

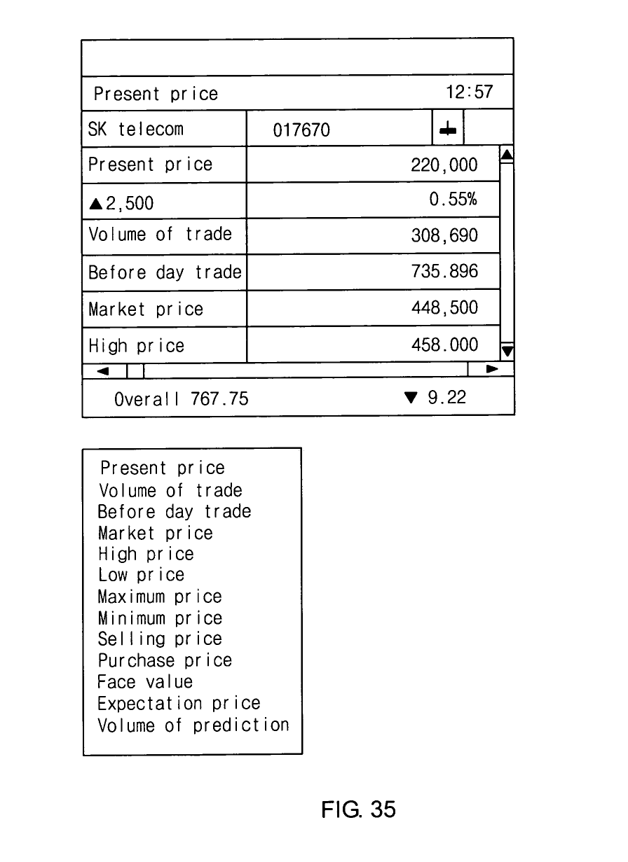

If a user selects a service such as the item (2) from the market price menu to a lower menu, the market price inquiry application displays a page as depicted in FIGS. 35 through 40 on the screen of the mobile terminal 100 in accordance with corresponding service.

In addition, the market price inquiry application generates a service request message on the basis of the selected information (for example, present price/asked price, stock price per day, chart, present futures price, present ECN price/asked price and index) (S107). And after the market price inquiry application gets socket-access to the relay server 140 through the BTS 110, the BSC/MSC 120 and the PDSN 130, and then constitutes a data transmission line, it transmits the same to the relay server 140 through the BTS 110, the BSC/MSC 120 and the PDSN 130 (S306, S307).

The relay server 140 analyzes a service request message transmitted from the mobile terminal 100, and transmits the same to corresponding server (namely, market price inquiry server 150).

The market price inquiry server 150 generates information corresponding to the service request message as a response message, and transmits the same to mobile terminal 100. Namely, the market price inquiry server 150 generates stock price per day of corresponding issue as a response message form, and transmits the same to mobile terminal 100.

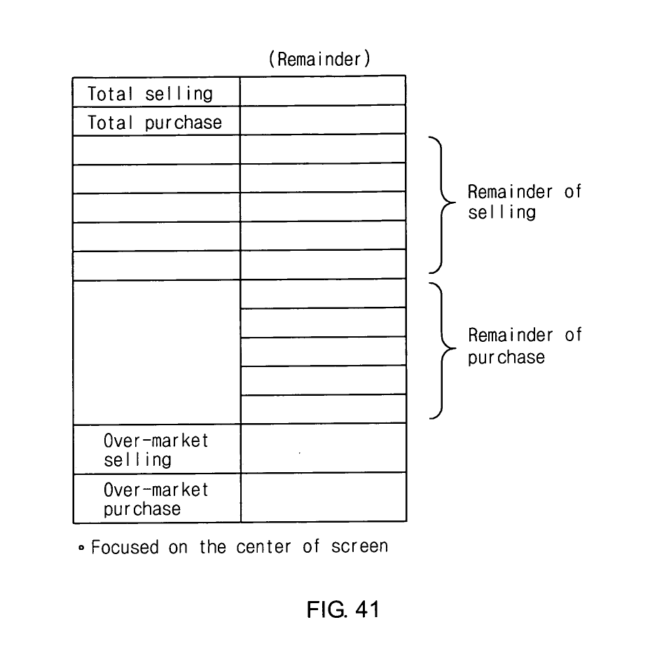

After that, a market price inquiry application displays t the service response message on the screen of the mobile terminal 100 as depicted in FIG. 41.

As described above, according to the present invention, because respective securities download separate stock application from a contents provision server using various information stored at a stock chip and uses the same and thus an interface in accordance with respective securities is integrated, a user's convenience is increased.

In addition, according to the present invention, because respective securities simplify the input procedure by integrating/using different ID/PASSWORD, a user's convenience is highly increased.

Furthermore, according to the present invention, because information related to an order and account is integrated and the information, which had to be respectively inputted to respective stock application, is transmitted to corresponding securities as one message, accessing time is shortened and then the overload of a communication network and user's call ratio are reduced.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A stock account/order service method performing a stock account/order service, the method comprising the steps of:
(1) displaying a lower menu page on a mobile terminal of the stock account/order service after a PIN authentication;
(2) generating an account/order service request message on the basis of stock chip information read from a stock chip and service request information corresponding to the lower menu and then transmitting the same to a relay server; and
(3) receiving a service response message corresponding to service request message from the relay server and displaying the same on the screen of a mobile terminal.

2. The method as claimed in claim 1, wherein the stock chip stores FCI (File Control Information) recording code information of each securities, basic information recording an effective term and an encryption method of the stock chip, stock account information recording a concerned issue group provided to a user, an issue code corresponding to each concerned issue and an issue name corresponding to the issue code, mobile stock information recording user's personal information and login ID/PASSWORD of securities, stock bank book key recording a stock account and issuance information and key information for the renewal, and PIN (Personal Identification Number) recording a stock chip password for a user authentication.

3. The method as claimed in claim 1, wherein the stock chip stores initial user information in the case that the stock chip is issued in a window of securities, and a user renews and re-adjusts the user information through the adjustment function of the mobile terminal after logging in through a PIN (Personal Identification Number) authentication.

4. The method as claimed in claim 1, wherein the step (1) further comprises the steps of:
confirming a PIN number inputted from a user; and
displaying a lower menu page corresponding to the stock account/order service on the screen of the mobile terminal in the case that after comparing the inputted PIN number with a PIN number stored at the stock chip, the comparison result is identical to each other, and displaying a service page selected from the user in the lower menu page on the screen of the mobile terminal.

5. The method as claimed in claim 1, wherein the step (2) further comprises the steps of:
reading information in according to a securities key, ID/PASSWORD of the securities, a dealing account number of a corresponding securities and a secret dealing number from the stock chip;
generating a service request message on the basis of stock chip information read from the stock chip and a lower menu service request of the account/order service; and
transmitting the service request message to a relay server.

6. The method as claimed in claim 1, wherein the step (3) further comprises the steps of:
analyzing the service request message transmitted from the mobile terminal, by the relay server;
transmitting a user-authenticated service request message to a securities server and a non-authenticated service request message to a market price inquiry server in accordance with the analysis result; and
receiving a service response message in response to the service request from the securities server and market price inquiry server, and then transmitting the same to the mobile terminal.

7. The method as claimed in claim 1, wherein the account service request message is any one of a balance request message, a withholdings request message, an order conclusion request message, a non-conclusion request message, a reservation inquiry request message, an ECN conclusion request message, and an ECN non-conclusion request message.

8. The method as claimed in claim 7, wherein a response message in response to the balance request message is a balance response message including volume of a balance in accordance with each issue in predetermined securities, a response message in response to the withholdings request message is a withholdings response message including possible order amount, possible re-purchase amount, D+2 withholdings, account receivable, possible inside-market amount and possible KOSDAQ amount, a response message in response to the order conclusion request message is an order conclusion response message including volume of a conclusion in accordance with each issue in predetermined securities, a response message in response to the non-conclusion request message is a non-conclusion response message including volume of a non-conclusion in accordance with each issue in predetermined securities, a response message in response to the reservation inquiry request message is a reservation inquiry response message including the state of reservation selling/purchase in accordance with each issue in predetermined securities, a response message in response to the ECN conclusion request message is an ECN conclusion response message including volume of an ECN conclusion in accordance with each issue in predetermined securities, a response message in response to the ECN non-conclusion request message is an ECN non-conclusion response message including volume of an ECN non-conclusion in accordance with each issue in predetermined securities.

9. The method as claimed in claim 1, wherein the order service request message is any one of a selling request message, a purchase request message, a amendment/cancellation request message, an ECN purchase request message, an ECN selling request message and ECN amendment/cancellation request message.

10. The method as claimed in claim 9, wherein a response message in response to the selling request message and the ECN selling request message is an selling response message including issue classification, kind of trade, volume of trade, and purchase price, a response message in response to the purchase request message and the ECN purchase request message is an selling response message including issue classification, kind of trade, volume of trade, and purchase price, a response message in response to the amendment/cancellation request message and the ECN amendment/cancellation request message is any one of an issue code, trade classification, kind of trade, volume of trade, purchase price, trade volume of initial order, and amendment/cancellation price.

11. A stock account/order service method using a mobile terminal which is able to remove a stock chip adding an additional service function such as a prepaid traffic function except for a stock service, the method comprising the steps of:
(1) confirming a PIN number inputted from a user;
(2) displaying a lower menu page corresponding to the stock account/order service on the screen of the mobile terminal in the case that after comparing the inputted PIN number with a PIN number stored at the stock chip, the comparison result is identical to each other, and displaying a service page selected from the user in the lower menu page on the screen of the mobile terminal;
(3) reading information in according to a securities key, ID/PASSWORD of the securities, a dealing account number of a corresponding securities and a secret dealing number from the stock chip;
(4) generating a service request message on the basis of stock chip information read from the stock chip and a lower menu service request of the account/order service;
(5) transmitting the service request message to a relay server; and
(6) receiving a service response message in response to the service request message from the relay server and then displaying the same on the screen of the mobile terminal.

12. A stock market information service method using a mobile terminal mounting a stock chip, the method comprising the steps of:
(a) generating a service request message corresponding to the selected item and then providing the service request message with a market price server in the case that a user of the mobile terminal activates a stock market price service and selects any one of market service items included in the stock market price service menu;
(b) providing a data corresponding to the service request message with the mobile terminal by the market price server in case of receiving the service request message; and
(c) generating a stock market price page corresponding to the data and the selected item and then displaying the generated market price page on the screen of the mobile terminal in case of receiving the data.

13. The method as claimed in claim 12, wherein the market price items include at least one of concerned issue, present price/asked price, stock price per day, chart, present futures price/asked price, present ECN price/asked price, index, and issue stock market conditions.

14. The method as claimed in claim 12, wherein the step (a) further comprises the steps of:
a-1) discriminating whether the selected item is the concerned item or not;
a-2) reading issues stored at a concerned group stored the stock chip, generating a concerned issue page including the read issues and then displaying the generated concerned issue page on the screen of the mobile terminal in case of the concerned group selection in the discrimination result; and
a-3) generating service request message corresponding to the selected issue and providing the service request message with a market price server in the case that the user selects any one of issues in the concerned issue page.

15. The method as claimed in claim 14, wherein the step (a-2) performs an PIN authentication before reading the issues from the stock chip.
